(19) United States
(12) Patent Application Publication
(10) Pub. No.: US 2009/0220137 A1
(43) Pub. Date: Sep. 3, 2009

(54) Automatic Multi-label Segmentation Of Abdominal Images Using Non-Rigid Registration

(75) Inventors: Christophe Chefd'hotel, Jersey City, NJ (US); Kinda Anna Saddi, Oxford (GB)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Corporate Research, Inc., Princeton, NY (US)

(21) Appl. No.: 12/390,763

(22) Filed: Feb. 23, 2009

Related U.S. Application Data
(60) Provisional application No. 61/032,237, filed on Feb. 28, 2008.

(51) Int. Cl. G06K 9/00; G06K 9/34

(52) U.S. Cl. 382/131; 382/173

(57) ABSTRACT

A method for segmenting an anatomical image, including: receiving a patient anatomical image; receiving a baseline anatomical image having pre-segmented labels, wherein the pre-segmented labels identify regions of interest in the baseline anatomical image; aligning the patient anatomical image with the baseline anatomical image to produce a transformation that when applied to the pre-segmented labels roughly identifies regions of interest in the patient anatomical image that correspond to the regions of interest in the baseline anatomical image; and updating the pre-segmented labels, which have been deformed by application of the transformation, with a new transformation that minimizes the likelihood of intensity distributions within the regions of interest of the patient anatomical image to produce a gradient image that better identifies the regions of interest of the patient anatomical image.

### CROSS-REFERENCE TO RELATED APPLICATION

This application claims the benefit of U.S. Provisional Application No. 61/032,237, filed Feb. 28, 2008, the disclosure of which is incorporated by reference herein in its entirety.

### BACKGROUND OF THE INVENTION

1. Technical Field

The present invention relates to multi-label segmentation and segmenting different organs of the abdomen.

2. Discussion of the Related Art

Image segmentation is the process of partitioning an image into different regions. A goal of image segmentation is to obtain a higher-level description of image content. For instance, in medical imaging, the segmentation of anatomical structures is a key element for computer-aided diagnosis and image-guided therapies.

### SUMMARY OF THE INVENTION

In an exemplary embodiment of the present invention, a method for segmenting an anatomical image, comprises: receiving a patient anatomical image: receiving a baseline anatomical image having pre-segmented labels, wherein the pre-segmented labels identify regions of interest in the baseline anatomical image; aligning the patient anatomical image with the baseline anatomical image to produce a transformation that when applied to the pre-segmented labels roughly identifies regions of interest in the patient anatomical image that correspond to the regions of interest in the baseline anatomical image; and updating the pre-segmented labels, which have been deformed by application of the transformation, with a new transformation that minimizes the likelihood of intensity distributions within the regions of interest of the patient anatomical image to produce a gradient image that better identifies the regions of interest of the patient anatomical image.

The method further comprises computing the new transformation, wherein computing the new transformation comprises: computing a gradient for all the regions of interest of the patient anatomical image; regularizing the gradient; and generating the new transformation by using the regularized gradient.

The new transformation is applied to the deformed pre-segmented labels by computing a composition of the deformed pre-segmented labels and the new transformation.

Computing the gradient for all the regions of interest of the patient anatomical image comprises: (1) for a region of interest of the patient anatomical image, computing a temporary image for the region of interest; computing an intensity distribution for the region of interest; and computing a gradient for the region of interest; (2) updating the gradient image with the gradient for the region of the interest; and repeating (1) and (2) until the gradient image has been updated with a gradient for all the regions of interest of the patient anatomical image.

The pre-segmented labels are repeatedly updated with new transformations until all the regions of interest of the patient anatomical image are better identified.

The patient anatomical image comprises an abdomen.

The patient anatomical image is a computed tomography (CT) image.

In an exemplary embodiment of the present invention, a system for segmenting an anatomical image, comprises: a memory device for storing a program: a processor in communication with the memory device, the processor operative with the program to: receive a patient anatomical image; receive a baseline anatomical image having pre-segmented labels, wherein the pre-segmented labels identify regions of interest in the baseline anatomical image; align the patient anatomical image with the baseline anatomical image to produce a transformation that when applied to the pre-segmented labels roughly identifies regions of interest in the patient anatomical image that correspond to the regions of interest in the baseline anatomical image; and update the pre-segmented labels, which have been deformed by application of the transformation, with a new transformation that minimizes the likelihood of intensity distributions within the regions of interest of the patient anatomical image to produce a gradient image that better identifies the regions of interest of the patient anatomical image.

The processor is further operative with the program to compute the new transformation, wherein when computing the new transformation the processor is further operative with the program to: compute a gradient for all the regions of interest of the patient anatomical image; regularize the gradient; and generate the new transformation by using the regularized gradient.

The new transformation is applied to the deformed pre-segmented labels by computing a composition of the deformed pre-segmented labels and the new transformation.

When computing the gradient for all the regions of interest of the patient anatomical image the processor is further operative with the program to: (1) for a region of interest of the patient anatomical image, compute a temporary image for the region of interest; compute an intensity distribution for the region of interest; and compute a gradient for the region of interest; (2) update the gradient image with the gradient for the region of the interest; and repeat (1) and (2) until the gradient image has been updated with a gradient for all the regions of interest of the patient anatomical image.

The pre-segmented labels are repeatedly updated with new transformations until all the regions of interest of the patient anatomical image are better identified.

The patient anatomical image comprises an abdomen.

The patient anatomical image is a CT image.

In an exemplary embodiment of the present invention, a computer readable medium tangibly embodying a program of instructions executable by a processor to perform method steps for segmenting an anatomical image is provided, the method steps comprising: receiving a patient anatomical image; receiving a baseline anatomical image having pre-segmented labels, wherein the pre-segmented labels identify regions of interest in the baseline anatomical image; aligning the patient anatomical image with the baseline anatomical image to produce a transformation that when applied to the pre-segmented labels roughly identifies regions of interest in the patient anatomical image that correspond to the regions of interest in the baseline anatomical image; and updating the pre-segmented labels, which have been deformed by application of the transformation, with a new transformation that minimizes the likelihood of intensity distributions within the regions of interest of the patient anatomical image to produce a gradient image that better identifies the regions of interest of the patient anatomical image.

The method steps further comprise computing the new transformation, wherein computing the new transformation comprises: computing a gradient for all the regions of interest of the patient anatomical image; regularizing the gradient; and generating the new transformation by using the regularized gradient.

The new transformation is applied to the deformed pre-segmented labels by computing a composition of the deformed pre-segmented labels and the new transformation.

Computing the gradient for all the regions of interest of the patient anatomical image comprises: (1) for a region of interest of the patient anatomical image, computing a temporary image for the region of interest; computing an intensity distribution for the region of interest; and computing a gradient for the region of interest; (2) updating the gradient image with the gradient for the region of the interest; and repeating (1) and (2) until the gradient image has been updated with a gradient for all the regions of interest of the patient anatomical image.

The pre-segmented labels are repeatedly updated with new transformations until all the regions of interest of the patient anatomical image are better identified.

The patient anatomical image comprises an abdomen.

The patient anatomical image is a CT image.

The foregoing features are of representative embodiments and are presented to assist in understanding the invention. It should be understood that they are not intended to be considered limitations on the invention as defined by the claims, or limitations on equivalents to the claims. Therefore, this summary of features should not be considered dispositive in determining equivalents. Additional features of the invention will become apparent in the following description, from the drawings and from the claims.

### BRIEF DESCRIPTION OF THE DRAWINGS

FIGS. 1A-C are images that illustrate multi-label segmentation according to an exemplary embodiment of the present invention;

FIGS. 2A and B are flowcharts that illustrate a method for multi-label segmentation according to an exemplary embodiment of the present invention; and

FIG. 3 is a block diagram of a system in which exemplary embodiments of the present invention may be implemented.

### DETAILED DESCRIPTION OF EXEMPLARY EMBODIMENTS

A hierarchical multi-label segmentation method based on non-rigid registration techniques to segment an arbitrary number of regions, according to an exemplary embodiment of the present invention, will hereinafter be described. In an exemplary embodiment of the method, first align an image I_{S}, with pre-segmented labels I_{T}_{_{N}}, to the image to be segmented I. Then, deform the pre-segmented labels I_{T}_{_{N}} and use them as a rough initialization to a multi-label segmentation technique, according to an exemplary embodiment of the present invention, where the deformed pre-segmented labels I_{T}_{_{N}}, are non-rigidly aligned to the image I by maximizing the likelihood of intensity distributions within different regions of interest. The intensity models and the corresponding posteriori distributions are estimated and updated throughout the alignment. The method according to an exemplary embodiment of the present invention allows a spatial relation between different regions of interest to be kept by finding local variations of shapes through one deformation field. An example of the method according to an exemplary embodiment of the present invention applied to segment eight regions of computed tomography (CT) images of the abdomen, is further described hereinafter.

A description of the statistical formulation of region-based segmentation will now be provided.

Let Ω ε R^{d} be open and bounded, and I:Ω→R be the image to be segmented. Assume that Ω is a partition composed of N independent disjoint regions Ωᵢ. This gives the simplified expression:

$$p ( I \vert P ( Ω ) ) = p ( I \vert \{ {Ω}_{1} , … , {Ω}_{N} \} ) = {\prod }_{i = 1}^{N} p ( I \vert {Ω}_{i} ) , \qquad ( 1 )$$

where p(I|Ωᵢ) denotes the probability of the image I where Ωᵢ is the region of interest. Assume that values of I at different locations of the same region can be modeled as an independent and identically distributed realization of the same random process. Define pᵢ(I(x)) as the probability density function of a random variable modeling intensity values I(x) in Ωᵢ. Given this model, the optimal partition can be obtained using a maximum likelihood principle, and minimizing the following energy proposed in [Zhu, S. C., Yuille, A. L.: Region competition: Unifying snakes, region growing, and bayes/MDL for multiband image segmentation. IEEE Transactions on Pattern Analysis and Machine Intelligence, vol. 18(9), 1996, pp. 884-900], the disclosure of which is incorporated by reference herein in its entirety:

$$E ( \{ {Ω}_{i} , … , {Ω}_{N} \} ) = {\sum }_{i = 1}^{N} {\int }_{{Ω}_{i}} - log {p}_{i} ( I ( x ) ) d x . \qquad ( 2 )$$

In the context of contour evolution, this energy can be expressed as the following energy to minimize:

$$E ( {Ω}_{i} , {p}_{i} ) = {\sum }_{i = 1}^{N} ( - {\int }_{{Ω}_{i}} log {p}_{i} - \frac{v}{2} {\int }_{{Γ}_{i}} d s ) , \qquad ( 3 )$$

where Γᵢ represent the contour of the region Ωᵢ, and the parameter ν controls the length of the contours. In particular, this energy is expressed in the context of level sets with a function φᵢ that represents the region Ωᵢ where φᵢ(x)>0 if and only if x ε Ωᵢ:

$$E ( {ϕ}_{i} , {p}_{i} ) = {\sum }_{i = 1}^{N} ( - {\int }_{Ω} H ( {ϕ}_{i} ) log {p}_{i} d x + \frac{v}{2} \vert vH ( {ϕ}_{i} ) \vert d x ) \qquad ( 4 )$$

This formulation does not respect implicitly the condition of disjoint regions, but the minimization of this energy ensures that a pixel is assigned to only one region according to the maximum likelihood principle.

A description of the method for non-rigid registration according to an exemplary embodiment of the present invention will now be provided.

In the following description, given two images I₁ and I₂, the registration problem is formulated as finding a mapping φ:Ω→Ω that maximizes a similarity measure between the images: S(I₁, I₂∘φ). First, maximize the local cross correlation between I and I_{S}, S_{LCC}(I,I_{T}_{_{N}}∘φ) and apply the mapping φ to I_{T}_{_{N}}. Second, maximize the likelihood of intensity distributions within different regions of interest: the multi-label similarity measure S_{ML}(I,I_{T}_{_{N}}∘φ). This similarity measure according to an exemplary embodiment of the present invention allows the segmentation of different regions of interest to be refined.

To find the optimal high-dimensional transformation, a sequence of transformations (φₖ)k=0, . . . ,+∞, is built by composition of small displacements as described in [Chefd'hotel, C., Hermosillo, G., Faugeras, O.: Flows of diffeomorphisms for multimodal image registration. In: Proceedings of IEEE International Symposium on Biomedical Imaging. (2002), pp. 753-756], the disclosure of which is incorporated by reference herein in its entirety,

φₖ₊₁=φₖ∘(φ_{id}+ανₖ), φ₀=φ_{id}, (5)

where φ_{id} is the identity transformation and νₖ is a velocity vector field that follows the gradient of the cost function to be minimized. Here, νₖ is obtained by computing the variational gradient of the cost function of the Local Cross-Correlation (LCC) similarity measure, i.e., ∇S_{LCC}(I,I_{S}∘φ) or the ML similarity measure ∇S_{ML}(I,I_{T}_{_{N}}∘φ).

The gradient νₖ is regularized using a fast recursive filtering technique. This approximates a Gaussian smoothing, as described, for example, in [Deriche, R.: Recursively implementing the Gaussian and its derivatives. In: Proceedings of the International Conference on Image Processing, Singapore (September 1992), pp. 263-267], that has proven very efficient in practice. Here, deriving the similarity measure energy according to a high-dimensional transformation results in a vector field ν. To guarantee a well-posed problem, this vector field has to be regularized. For this purpose, different techniques have been proposed. The approach proposed in [Christensen, G. E., Rabbit, R. D., Miller, M. I.: Deformable templates using large deformation kinematics. IEEE Transactions on Image Processing, vol. 5(10), 1996, pp. 1435-1447], the disclosure of which is incorporated by reference herein in its entirety, solves the registration problem using a partial differential equation and has the advantage of capturing large deformations. In the method according to an exemplary embodiment of the present invention, a Gaussian filtering is used that can be seen as a variant of the fluid-approach described in Christensen et al.

The previous iterative scheme (Eq. 5) is repeated until convergence, and can be seen as the discretization (via Taylor expansion) of the transport equation in the Eulerian frame:

$$\frac{\partial {φ}_{t}}{\partial t} = - D {φ}_{t} \cdot v , {φ}_{0} = {φ}_{id} , \qquad ( 6 )$$

where Dφₜ stands for the Jacobian matrix of φₜ. Here, large deformations are possible because the regularization is applied to the velocity rather than the deformation described in [Dupuis, P., Grenander, U., Miller, M.: Variational problems on flows of diffeomorphisms for image matching. Quarterly of Applied Mathematics LVI(3), (1998), pp. 587-600], which details the suitable regularity conditions on the velocity field to generate a diffeomorphism.

The method according to an exemplary embodiment of the present invention is embedded in a coarse-to-fine strategy. This reduces the computational cost by working with less data at lower resolutions. This also allows large displacements to be recovered, and helps avoiding local minima. In the method according to an exemplary embodiment of the present invention, five-levels of multi-resolutions are used.

To refine the segmentation, in accordance with an exemplary embodiment of the present invention, a multi-labeled template matching algorithm that recovers local deformations of the shape obtained in the previous section is provided. Consider the registration framework, an image I_{T}_{_{N}} ε Ω composed of N disjoint regions is defined, each region with a different label. This image can be seen as the union of N images representing a different region:

$${I}_{{T}_{N}} ≅ {\sum }_{i = 1}^{N} ( Ii ) . \qquad ( 7 )$$

Formulate the problem as finding a transformation φ:Ω→Ω that minimizes the likelihood between the intensity distribution functions of different regions pᵢ according to I and I_{T}_{_{N}}. Thus, the following energy is minimized:

$${S}_{ML} ( I , {I}_{{T}_{N}} \cdot φ ) = - {\int }_{Ω} ( {\sum }_{i = 1}^{N} ( {I}_{i} \cdot φ ) log {p}_{i} ( I ( x ) ) ) d x . \qquad ( 8 )$$

In this equation, I_{T}_{_{N}}∘φ is the warped multi-labeled template and ∘ the composition operator. Since an optimal transformation φ is wanted, the derivation of the energy leads to the following gradient descent:

$$∇ {S}_{ML} ( I , {I}_{{T}_{N}} \cdot φ ) = {\sum }_{i = 1}^{N} ∇ ( {I}_{i} \cdot φ ) ( log {p}_{i} ( I ( x ) ) ) . \qquad ( 9 )$$

The density probability function of different regions is as follows:

$${p}_{i} ( j ) = \frac{1}{\vert {Ω}_{i} \vert} {\int }_{Ω}^{ } ( {I}_{i} \cdot φ ) \partial ( I ( x ) - j ) d x . \qquad ( 10 )$$

With the method according to an exemplary embodiment of the present invention, local shape variations are found by deforming the multi-labeled image I_{T}_{_{N}} through the transformation φ. This formulation allows an arbitrary number of regions to be segmented by optimizing only one function φ, in contrast to contour evolution methods, such as level set, where N functions are required to model contours (e.g., a level set function modeling each contour of a region Ω). The increasing number of contours in level set methods quickly becomes a complex memory problem. This problem is bypasses by encrypting the information of the different regions in a single multi-label image I_{T}_{_{N}}. In addition, the method, in accordance with an exemplary embodiment of the present invention, provides a consistent structural relationship between the different regions where one transformation φ is optimized.

Algorithm 1 (show below) describes how to compute the gradient of the similarity measure ∇S(I,I_{T}_{_{N}}∘φ). For each region, create a temporary binary image Iᵢ of the region Ωᵢ and compute the corresponding probability density function pᵢ. The image Iᵢ is used when computing the gradient descent of this particular region ∇(Iᵢ∘φ)(log pᵢ(I(x))). The image Iᵢ is chosen to be binary to avoid bias between different regions. The global gradient of the similarity measure of different regions is then updated.
Algorithm 1 Similarity Measure for segmentation
Require: I,I_{T}_{_{N}}=first approximation of N regions, φ.
Ensure: The gradient of the similarity measure ∇S(I,I_{T}_{_{N}}∘φ).
1: for Each region i in Ω do
2: Create a temporary image Iᵢ corresponding to the region Ωᵢ.
3: Compute pᵢ for the region Ωᵢ (equation (10)).
4: Compute ∇S(I,Iᵢ∘φ)=∇(Iᵢ∘φ)(log pᵢ(l(x))).
5: Update ∇S(I,I_{T}_{_{N}}∘φ)+=∇S(I,Iᵢ∘φ).
6: end for

A description of experimental results of the multi-label segmentation method according to an exemplary embodiment of the present invention will now be provided.

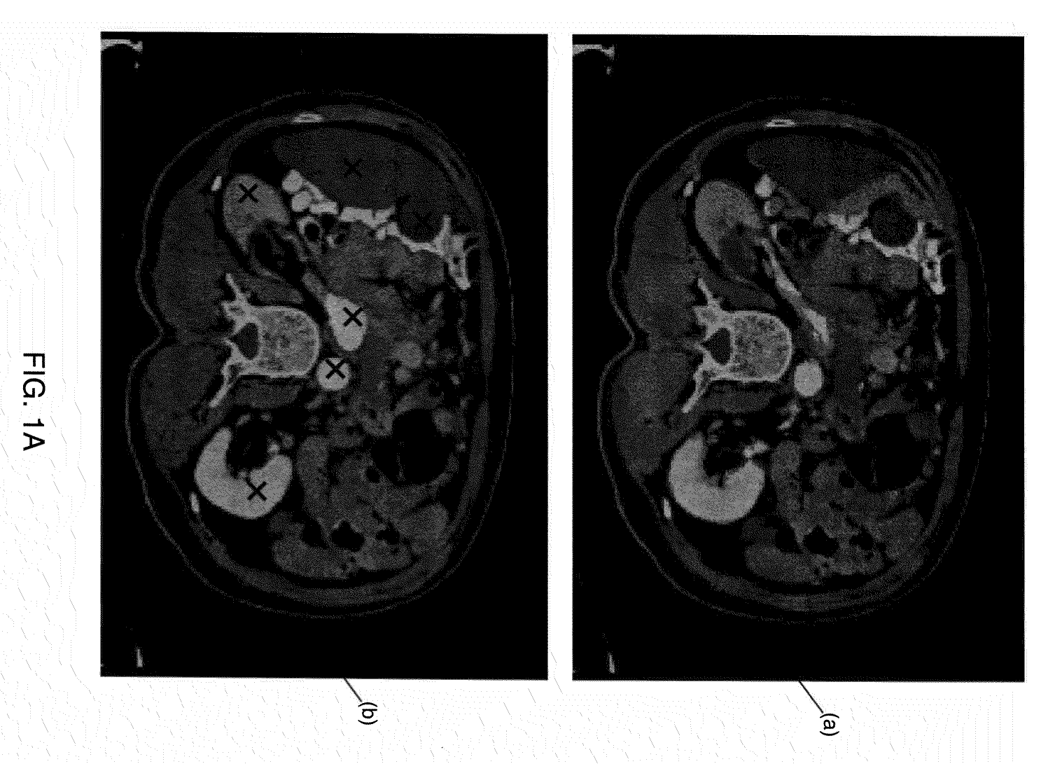

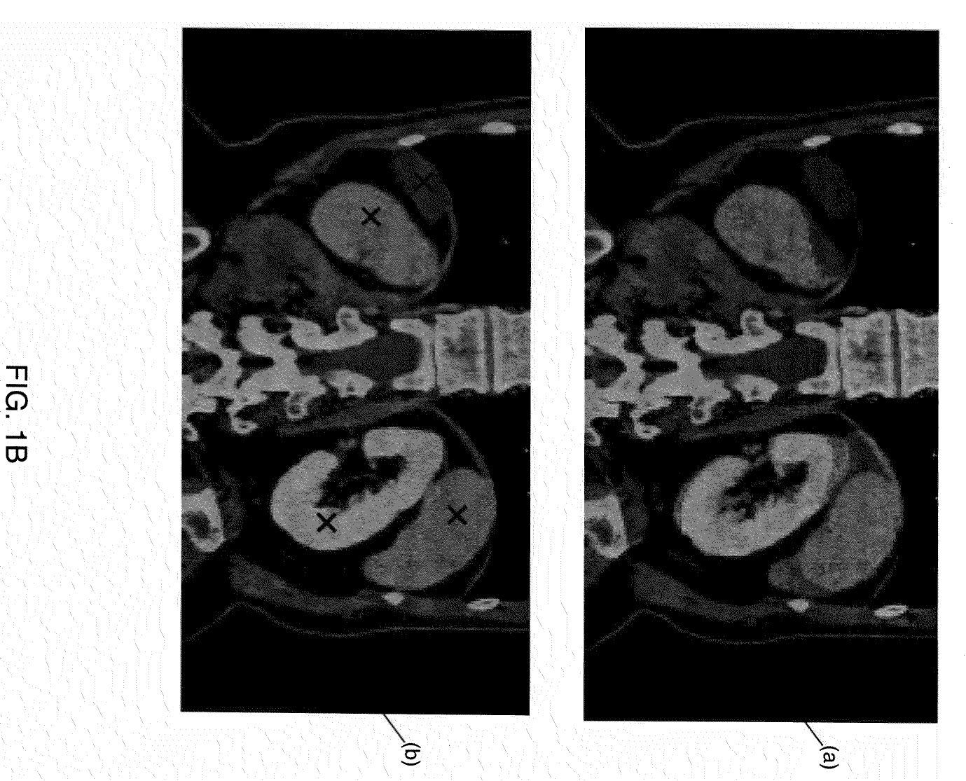

FIGS. 1A-C show results of the segmentation, in accordance with an exemplary embodiment of the present invention. Here, eight different regions: liver, gallbladder, right kidney, left kidney, aorta, vena, cava, spleen and the background, were segmented. Image (a) in FIGS. 1A-C represents a rough initialization of I_{T}_{_{N}} (hereinafter also referred to as T_{T}_{_{N}}) and image (b) in FIGS. 1A-C is a result of the multi-segmentation method according to an exemplary embodiment of the present invention, applied to its corresponding image (a).

In image (b) of FIG. 1A, six of the segmented regions are marked with an “X”. In image (b) of FIG. 1B, four of the segmented regions are marked with an “X”. In image (b) of FIG. 1C, three of the segmented regions are marked with an “X”. The marked regions in image (b) of FIGS. 1A-C clearly illustrate that the multi-label segmentation correctly delineates the different organs in the abdomen without leaking or overestimation.

The liver segmentation result was compared to a ground-truth using five metrics: volumetric overlap, relative absolute difference, average symmetric absolute surface distance, symmetric RMS surface distance and maximum symmetric absolute surface distance. These metrics were evaluated using by assigning a score as described, for example, in [van Ginneken, B., Heimann, T., Styner, M.: 3d segmentation in the clinic: A grand challenge. In: 3D Segmentation in the Clinic: A Grand Challenge, MICCAI 2007 (2007), pp. 7-15]. Table 1 (shown below) presents the segmentation results.

TABLE 1

| Metric | V [%] | Score | dv [%] | Score | d_{moy} [mm] | Score |
|---|---|---|---|---|---|---|
| Liver | 11.34 | 57 | 1.95 | 90 | 1.5 | 60 |

| Metric | drms [%] | Score | dₘₐₓ [%] | Score | Score | total |
|---|---|---|---|---|---|---|
| Liver | 3.4 | 50 | 27.3 | 65 | | 64 |

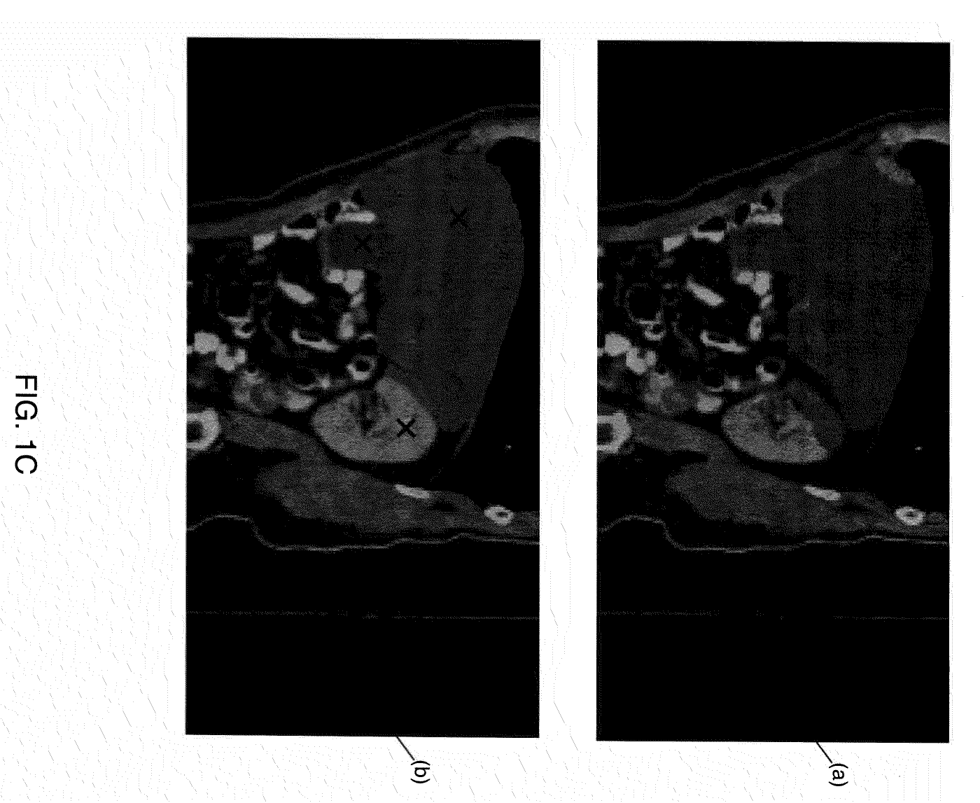

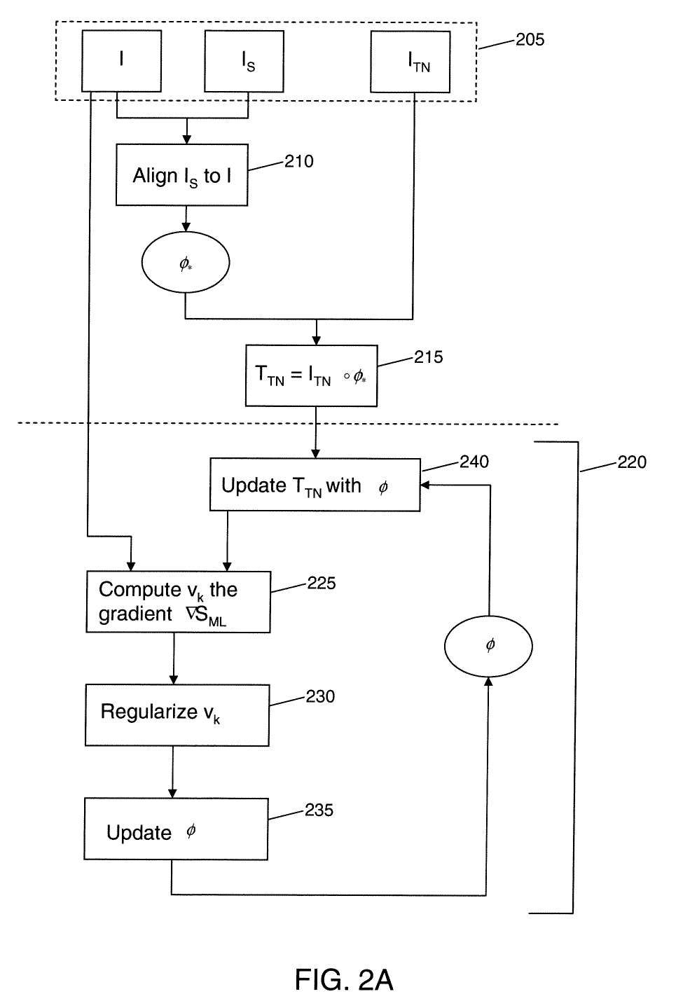

FIGS. 2A and B are flowcharts that illustrate a method for multi-label segmentation according to an exemplary embodiment of the present invention.

In FIG. 2A, an image I, an image I_{S} and pre-segmented labels I_{T}_{_{N}} are input (205). In this example, the image I is a CT image of a patient's abdomen. It is to be understood, however, that this image could be of virtually any part of the patient's anatomy. In addition, this image could be have been acquired by a variety of imaging modalities, one such exemplary modality being magnetic resonance (MR). In this example, the image I_{S} is a baseline image that corresponds to a patient's abdomen. It is to be understood that image I_{S} is not the same image as image I. Further, image I_{S} has corresponding pre-segmented labels I_{T}_{_{N}}. The pre-segmented labels I_{T}_{_{N}} are a good segmentation of certain organs in the abdomen of the image I_{S}. The pre-segmented labels I_{T}_{_{N}} are manually marked by a doctor, for example.

After the images I and I_{S} are input, they are aligned (210). This is done by using the fluid-based technique described by equations 5 and 6 with an LCC similarity measure, for example. The result of this alignment is a mapping/transformation φ*. This mapping/transformation φ* is applied to I_{T}_{_{N}} to get T_{T}_{_{N}} (215). For example, the warping is applied by using tri-linear interpolation, e.g., I_{T}_{_{N}}∘φ*. Hereinafter, I_{T}_{_{N}}∘φ* may be referred to just as T_{T}_{_{N}}. In other words, T_{T}_{_{N}} is a rough initialization of the pre-segmented labels I_{T}_{_{N}} for the image I. As already mentioned, an example of this rough initialization is shown in image (a) of FIGS. 1A-C.

Now the roughly-initialized (e.g., deformed) pre-segmented labels image T_{T}_{_{N}} is aligned to the image I by maximizing the likelihood of intensity distributions (220). In other words, the pre-segmented labels image T_{T}_{_{N}} is updated with a new mapping/transformation φ until a desired refined segmentation of the organs is achieved. This process will now be described.

Using the image I and the roughly-initialized pre-segmented labels image T_{T}_{_{N}}, νₖ, which is a gradient of the similarity measure ∇S(I,I_{T}_{_{N}}∘φ) (e.g., eq. (9)), is computed (225). This step will be described in more detail hereinafter with reference to FIG. 2B. The gradient νₖ is regularized (230) with Gaussian smoothing. A new mapping/transformation φ is computed by applying the regularized gradient to eq. (5) (235). This can be seen as an instance of Christensen et al.'s fluid registration, discussed previously. The new mapping/transformation φ is used to update the roughly-initialized pre-segmented labels image (240), e.g., by computing T_{T}_{_{N}}∘φ. The sequence of steps (outlined in 220) is repeated until the cost function of the similarity measure stops decreasing, for example. As already mentioned, an example of the results of aligning the pre-segmented labels image T_{T}_{_{N}} to the image I is shown in image (b) of FIGS. 1A-C.

The left-hand side of FIG. 2B illustrates the process of computing νₖ in step 225. This process is done for every label i. An example of several labels that will undergo this process is shown by 1, 2, 3, 4 and 5 (including the background identified as a separate region) identified as T_{T}_{_{N}} on the right-hand side of FIG. 2B. Using the image I and the deformed pre-segmented labels image T_{T}_{_{N}} from box 215 (the example of which is shown on the right-hand side of this figure), a temporary image Iᵢ∘φ for the region Ωᵢ is created (225a). The temporary image being I₁ for label 1 (i.e., region Ω₁). Using equation (10), the intensity distribution function for the region Ωᵢ is computed (225b). The gradient of the similarity measure of the temporary image ∇S(I,Iᵢ∘φ)=∇(Iᵢ∘φ)log pᵢ(I(x))) is computed (225c). The final gradient of the similarity measure, i.e., the final gradient image ∇S(I,I_{T}_{_{N}}∘φ)+=∇S(I,Iᵢ∘φ), is updated by concatenating the final gradient image with the gradients of the current label. This process is then repeated for I₂ for label 2 (i.e., region Ω₂, I₃ for label 3 (i.e., region Ω₃), I₄ for label 4 (i.e., region Ω₄) and I₅ for label 5 (i.e., region Ω₅). A example of the different regions and temporary images for each label is shown by the shaded labels 1, 2, 3, 4 and 5 in images I₁,I₂, I₃, I₄ and I₅, of FIG. 2B, respectively.

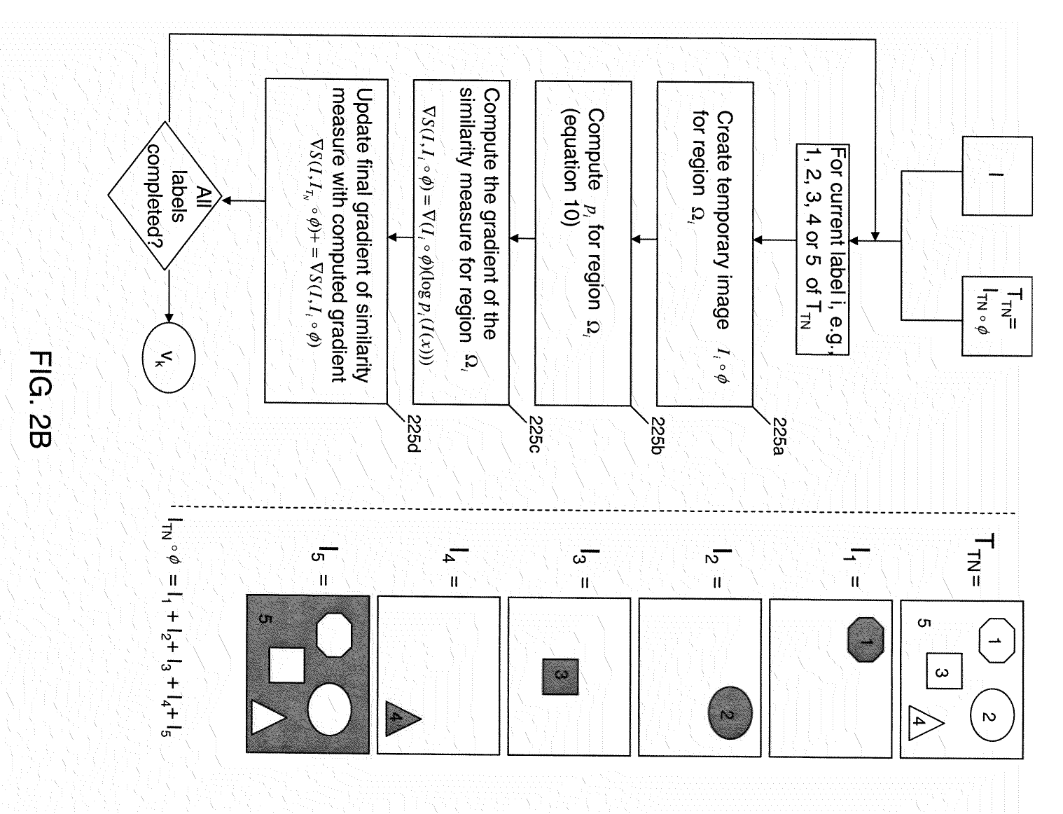

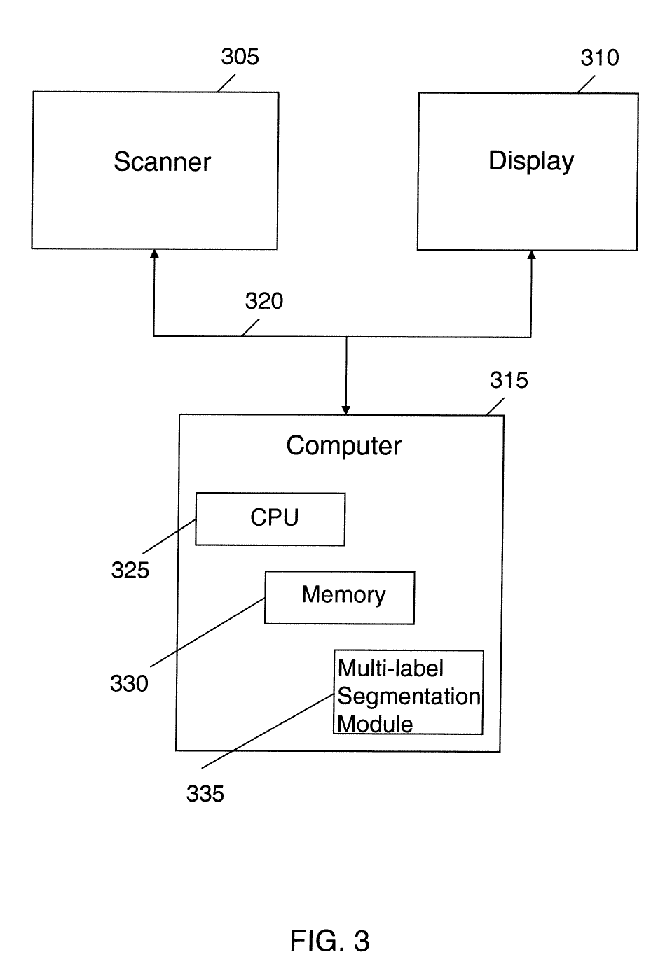

A system in which exemplary embodiments of the present invention may be implemented will now be described with reference to FIG. 3. As shown in FIG. 3, the system includes a scanner 305, a computer 315 and a display 310 connected over a wired or wireless network 320. The scanner 305 may be an MR or CT scanner, for example. The computer 315 includes, inter alia, a central processing unit (CPU) 325, a memory 330 and a multi-label segmentation module 335 that includes program code for executing methods in accordance with exemplary embodiments of the present invention. The display 310 is a computer screen, for example.

It is understood that the present invention may be implemented in various forms of hardware, software, firmware, special purpose processors, or a combination thereof. In one embodiment, the present invention may be implemented in software as an application program tangibly embodied on a program storage device (e.g., magnetic floppy disk, RAM, CD ROM, DVD, ROM. and flash memory). The application program may be uploaded to, and executed by, a machine comprising any suitable architecture.

It is also understood that because some of the constituent system components and method steps depicted in the accompanying figures may be implemented in software, the actual connections between the system components (or the process steps) may differ depending on the manner in which the present invention is programmed. Given the teachings of the present invention provided herein, one of ordinary skill in the art will be able to contemplate these and similar implementations or configurations of the present invention.

It is further understood that the above description is only representative of illustrative embodiments. For convenience of the reader, the above description has focused on a representative sample of possible embodiments, a sample that is illustrative of the principles of the invention. The description has not attempted to exhaustively enumerate all possible variations. That alternative embodiments may not have been presented for a specific portion of the invention, or that further undescribed alternatives may be available for a portion, is not to be considered a disclaimer of those alternate embodiments. Other applications and embodiments can be implemented without departing from the spirit and scope of the present invention.

It is therefore intended, that the invention not be limited to the specifically described embodiments, because numerous permutations and combinations of the above and implementations involving non-inventive substitutions for the above can be created, but the invention is to be defined in accordance with the claims that follow. It can be appreciated that many of those undescribed embodiments are within the literal scope of the following claims, and that others are equivalent.

What is claimed is:

1. A method for segmenting an anatomical image, comprising:
receiving a patient anatomical image;
receiving a baseline anatomical image having pre-segmented labels, wherein the pre-segmented labels identify regions of interest in the baseline anatomical image;
aligning the patient anatomical image with the baseline anatomical image to produce a transformation that when applied to the pre-segmented labels roughly identifies regions of interest in the patient anatomical image that correspond to the regions of interest in the baseline anatomical image; and
updating the pre-segmented labels, which have been deformed by application of the transformation, with a new transformation that minimizes the likelihood of intensity distributions within the regions of interest of the patient anatomical image to produce a gradient image that better identifies the regions of interest of the patient anatomical image.

2. The method of claim 1, further comprising computing the new transformation, wherein computing the new transformation comprises:
computing a gradient for all the regions of interest of the patient anatomical image;
regularizing the gradient; and
generating the new transformation by using the regularized gradient.

3. The method of claim 1, wherein the new transformation is applied to the deformed pre-segmented labels by computing a composition of the deformed pre-segmented labels and the new transformation.

4. The method of claim 2, wherein computing the gradient for all the regions of interest of the patient anatomical image comprises:
(1) for a region of interest of the patient anatomical image,
computing a temporary image for the region of interest;
computing an intensity distribution for the region of interest; and
computing a gradient for the region of interest;
(2) updating the gradient image with the gradient for the region of the interest; and
repeating (1) and (2) until the gradient image has been updated with a gradient for all the regions of interest of the patient anatomical image.

5. The method of claim 1, wherein the pre-segmented labels are repeatedly updated with new transformations until all the regions of interest of the patient anatomical image are better identified.

6. The method of claim 1, wherein the patient anatomical image comprises an abdomen.

7. The method of claim 1, wherein the patient anatomical image is a computed tomography (CT) image.

8. A system for segmenting an anatomical image, comprising:
a memory device for storing a program:
a processor in communication with the memory device, the processor operative with the program to:
receive a patient anatomical image;
receive a baseline anatomical image having pre-segmented labels, wherein the pre-segmented labels identify regions of interest in the baseline anatomical image;
align the patient anatomical image with the baseline anatomical image to produce a transformation that when applied to the pre-segmented labels roughly identifies regions of interest in the patient anatomical image that correspond to the regions of interest in the baseline anatomical image; and
update the pre-segmented labels, which have been deformed by application of the transformation, with a new transformation that minimizes the likelihood of intensity distributions within the regions of interest of the patient anatomical image to produce a gradient image that better identifies the regions of interest of the patient anatomical image.

9. The system of claim 8, wherein the processor is further operative with the program to compute the new transformation, wherein when computing the new transformation the processor is further operative with the program to:
compute a gradient for all the regions of interest of the patient anatomical image;
regularize the gradient; and
generate the new transformation by using the regularized gradient.

10. The system of claim 8, wherein the new transformation is applied to the deformed pre-segmented labels by computing a composition of the deformed pre-segmented labels and the new transformation.

11. The system of claim 9, wherein when computing the gradient for all the regions of interest of the patient anatomical image the processor is further operative with the program to:
(1) for a region of interest of the patient anatomical image,
compute a temporary image for the region of interest;
compute an intensity distribution for the region of interest; and
compute a gradient for the region of interest;
(2) update the gradient image with the gradient for the region of the interest; and
repeat (1) and (2) until the gradient image has been updated with a gradient for all the regions of interest of the patient anatomical image.

12. The system of claim 8, wherein the pre-segmented labels are repeatedly updated with new transformations until all the regions of interest of the patient anatomical image are better identified.

13. The system of claim 8, wherein the patient anatomical image comprises an abdomen.

14. The system of claim 8, wherein the patient anatomical image is a computed tomography (CT) image.

15. A computer readable medium tangibly embodying a program of instructions executable by a processor to perform method steps for segmenting an anatomical image, the method steps comprising:
receiving a patient anatomical image;
receiving a baseline anatomical image having pre-segmented labels, wherein the pre-segmented labels identify regions of interest in the baseline anatomical image;
aligning the patient anatomical image with the baseline anatomical image to produce a transformation that when applied to the pre-segmented labels roughly identifies regions of interest in the patient anatomical image that correspond to the regions of interest in the baseline anatomical image; and
updating the pre-segmented labels, which have been deformed by application of the transformation, with a new transformation that minimizes the likelihood of intensity distributions within the regions of interest of the patient anatomical image to produce a gradient image that better identifies the regions of interest of the patient anatomical image.

16. The computer readable medium of claim 15, the method steps further comprising computing the new transformation, wherein computing the new transformation comprises:
computing a gradient for all the regions of interest of the patient anatomical image;
regularizing the gradient; and
generating the new transformation by using the regularized gradient.

17. The computer readable medium of claim 15, wherein the new transformation is applied to the deformed pre-segmented labels by computing a composition of the deformed pre-segmented labels and the new transformation.

18. The computer readable medium of claim 16, wherein computing the gradient for all the regions of interest of the patient anatomical image comprises:
(1) for a region of interest of the patient anatomical image,
computing a temporary image for the region of interest;
computing an intensity distribution for the region of interest; and
computing a gradient for the region of interest;
(2) updating the gradient image with the gradient for the region of the interest; and
repeating (1) and (2) until the gradient image has been updated with a gradient for all the regions of interest of the patient anatomical image.

19. The computer readable medium of claim 15, wherein the pre-segmented labels are repeatedly updated with new transformations until all the regions of interest of the patient anatomical image are better identified.

20. The computer readable medium of claim 15, wherein the patient anatomical image comprises an abdomen.

21. The computer readable medium of claim 15, wherein the patient anatomical image is a computed tomography (CT) image.
